(19) United States
(12) Patent Application Publication
(10) Pub. No.: US 2021/0229286 A1
(43) Pub. Date: Jul. 29, 2021

(54) CYBER-PHYSICAL SYSTEM-BASED REMOTE CONTROL FRAMEWORK FOR ROBOTS

(71) Applicant: HARBIN INSTITUTE OF TECHNOLOGY, Harbin (CN)

(72) Inventors: Jihong Yan, Harbin (CN); Qixue Wu, Harbin (CN); Mingyang Zhang, Harbin (CN)

(21) Appl. No.: 17/139,610

(22) Filed: Dec. 31, 2020

(30) Foreign Application Priority Data
Jan. 10, 2020 (CN) 202010026757.3

(51) Int. Cl. B25J 9/16; G05B 19/4155

(52) U.S. Cl. CPC B25J 9/1689; G05B 2219/50391; G05B 19/4155

(57) ABSTRACT

A cyber-physical system (CPS)-based remote control system for a robot is provided to solve the problems that the traditional teaching and control methods for an industrial robot fail to meet the requirements of intelligent manufacturing and lack in the visual scene. The CPS-based remote control system combines with the visual virtual environment to improve the user experience, which not only improves an efficiency of the control system for the robot, but also brings a new interaction mode with robots in the field of intelligent manufacturing.

### CROSS-REFERENCE TO RELATED APPLICATIONS

This application claims the benefit of priority from Chinese Patent Application No. 202010026757.3, filed on Jan. 10, 2020. The content of the aforementioned application, including any intervening amendments thereto, is incorporated herein by reference in its entirety.

### TECHNICAL FIELD

The present application relates to control technologies of intelligent manufacturing, and more particularly to a cyber-physical system (CPS)-based remote control system for a robot.

### BACKGROUND

Cyber-physical system (CPS) is the core of intelligent manufacturing.

Specifically, the CPS is an embedded system that handles physical and information environments. A model of the CPS information terminal is connected to one or more control units, so that the model interacts with the real world under human guidance, while collecting and processing data from sensors and actuators at the same time. The interaction with other physical or digital systems and the data processing are the bases of the CPS. In other words, the CPS can change the way that people interact with the physical world, and becomes an important link to realize a close integration and coordination of computing resources and physical resources. The key of the CPS is to realize the mutual perception, understanding and integration of human, machines and objects in an interconnected environment.

In practice, the production mode of manufacturing companies is shifting from mass production to personalized production at a fast speed, and industrial robots have played a vital role in the mass production. Due to the continuous development of smart factories at the present stage, industrial robots have begun to play an increasingly important role in promoting smart manufacturing by using their own technological advantages and through combination with microprocessors and artificial intelligence. As for the robot applications, the interconnection and intercommunication of industrial robots through the Internet is regarded as an important part of improving the industrial level. It depends on the control of robots, and the monitoring of robots contributes to the remote inspection for robot movement.

Therefore, a CPS-based remote control system for a robot is established to realize an interaction between the physical system and the information system at the industrial robot level, and to provide a solution for the participation of industrial robots in specific flexible production under intelligent manufacturing, thereby providing important theoretical research significance and application value for promoting human-machine interaction, and transformation and upgrading of the manufacturing industry.

Currently, in the traditional control methods for an industrial robot, the robot is mainly applied after a point coordinate teaching. With the rapid development of digital technology, the robot teaching operation interfaces or operation methods in the prior art can no longer satisfy an interactive operation of users and future intelligent factories. Controlling robots in a simpler and more visualized way in the production is desired. In addition to the traditional control methods, other control methods such as offline simulation also fail to solve the above-mentioned problem in essence, and fail to meet the needs of various aspects of intelligent manufacturing. In summary, the control methods in the prior art lack an interactive environment to achieve customization in visualized scenarios.

### SUMMARY

An object of the present disclosure is to provide a cyber-physical system (CPS)-based remote control system for a robot, in order to solve the problems that the traditional teaching and control methods for an industrial robot cannot meet the requirements of intelligent manufacturing and lack in the visual scene.

The present disclosure provides a CPS-based remote control system for a robot, comprising:

a modeling module for constructing a physical scene model of the robot according to a parameter of a real indoor environment where the robot is located, and constructing a 3D model of the robot according to a size parameter of the robot;

a render module for rendering the physical scene model and the 3D model of the robot;

a simulation module for constructing a rendered physical scene model and a rendered 3D model of the robot, thereby obtaining a simulation scene;

an instruction module for configuring a script of joints of the rendered 3D model of the robot in the simulation scene, collecting a model control signal to drive the rendered 3D model of the robot, and generating a string command according to a motion state of the rendered 3D model of the robot in the simulation scene; wherein the string command is provided for controlling movements of the robot in a real scene; and

a server module for sending the string command to a host computer of a controller of the robot.

Compared to the prior art, the present invention has the following beneficial effects.

The CPS-based remote control system for a robot of the present invention gets rid of the features which use teaching as a semi-closed loop control of the robot in traditional control methods, and realizes a visual operation for operators such as customers, factory workers in specific actual personalized production. The traditional control methods are only suitable for a single production mode with a large output, but personalized production mode with a small batch has become a trend at the present stage. Therefore, the CPS-based remote control system for the robot of the present invention combines with the visual virtual environment to improve the user experience, which not only improves an efficiency of the control system for the robot, but also brings a new interaction mode with robots in the field of intelligent manufacturing.

### BRIEF DESCRIPTION OF THE DRAWINGS

FIG. 1 is a block diagram of a CPS-based remote control system for a robot according to an embodiment of the present disclosure.

FIG. 2 is a block diagram of a monitoring system for the robot according to an embodiment of the present disclosure.

### DETAILED DESCRIPTION OF EMBODIMENTS

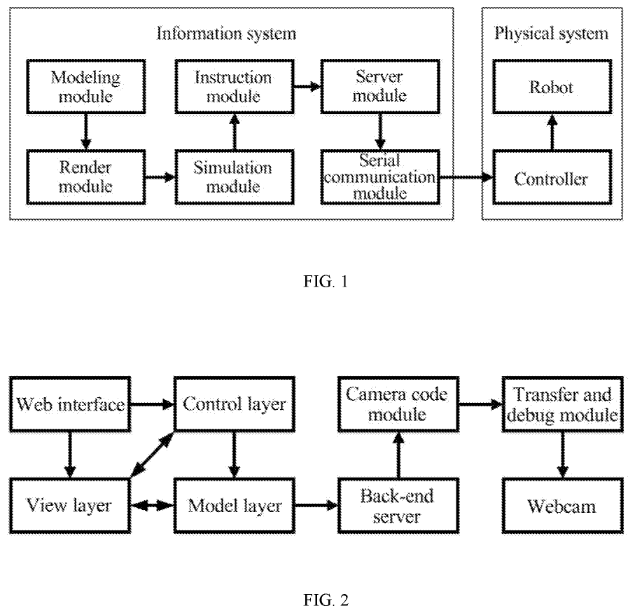

The embodiment is illustrated with reference to FIG. 1. The embodiment provides a CPS-based remote control system for a robot, which is implemented based on a physical system of the robot.

The physical system of the robot is realized by an Epson C4-A901s six-degree-of-freedom robot, where the robot includes several joints and arms capable of realizing a rotation and a translation. The control part of the robot is an Epson RC700 control box, which can adopt the SPEL+ language that the robot can recognize to design a Main program to drive the robot. The robot is further equipped with a clamp-type pneumatic finger, a controllable solenoid valve, an air pump, a self-designed and 3D printed robot pneumatic finger extension and a self-designed and 3D printed material box to facilitate the carrying and clamping operations.

Specifically, the embodiment provides a CPS-based remote control system (i.e., an information system) for a robot, including a modeling module, a render module, a simulation module, an instruction module and a server module.

The modeling module is provided for constructing a physical scene model of the robot (i.e., a physical system of the robot in a real scene) according to parameters of a real indoor environment where the robot is located, and constructing a 3D model of the robot according to its size parameters. The physical scene model includes an indoor space model and an indoor object model.

The render module is provided for rendering the physical scene model and the 3D model of the robot. The render module enables the model obtained in the modeling module to be displayed more realistically in the information system, and the realistic physical effects and animation rendering can be displayed more intuitively on the display platform at the same time. In addition, the render module can further locate the center of the model.

The simulation module is provided for constructing a rendered physical scene model and a rendered 3D model of the robot, thereby obtaining a simulation scene. In the simulation module, a Unity3D engine is provided for constructing a rendered indoor object model and the rendered 3D model of the robot in a rendered indoor space model according to the real scene, thereby obtaining the simulation scene consistent with the real scene. According to an open source script editor MonoDevelop, necessary scripts such as a joint rotation script, a perspective rotation movement script, and a collision script are designed to achieve required functions. The Unity3D engine is a cross-multiplatform tool for developing interactive contents such as 3D video games, architectural visualization, and real-time 3D animation, in which an open source script editor of the engine can improve the flexibility of the overall system.

The instruction module is provided for configuring the motion joint scripts of the rendered robot model in the simulation scene, collecting the model control signal to drive the rendered model of the robot, and generating a string command according to the motion state of the rendered model in the simulation scene. The string command is provided for controlling the movement of robot in a real scene. The model control signals are artificially set. The model can be directly moved on the corresponding simulation interface via a mouse, or the model can be touched by the finger on the simulation interface via a touch screen.

The server module is provided with a communication module for sending the string command to a host computer of the controller of the robot. Specifically, a server is established in the Unity3D engine, so that the generated string commands are remotely transmitted to the host computer in front of the controller of the robot.

Furthermore, this embodiment uses a Hikvision webcam as a hardware device to cooperate with a web server to monitor the robot on a monitoring webpage. The monitoring system adopts a bower/server (B/S) architecture and realizes a remote access and an interaction based on the Web. The development environment is Eclipse, and the Web publisher is Apache Tomcat. The specific technologies in the monitoring system include a front-end and a back-end technologies, a page interaction technology, and an underlying communication technology. A back-end connection part of the webcam includes a camera code module, a transfer and debug module, and a webcam. As shown in FIG. 2, the specific technologies include the following parts:

1) A front-end technology, in which Java Server Pages (JSP) are adopted to make it convenient to call variables in the server background to set the page content. The Cascading Style Sheets (CSS) technology is adopted to typeset and beautify the page style. The JavaScript language is adopted to realize a dynamic response of the front end.

2) A back-end technology, which mainly performs a model description and a method encapsulation for various element objects displayed on the page.

3) A page interaction technology, in which a Model-View-Controller (MVC) design mode separates the front-end response, the back-end calculation and data processing flow into independent modules, reducing a mutual influence of each part, and greatly improving the scalability of the website system. In Java Web, a combined mode of JSP+Servlet+JavaBean can be used to achieve a function of the MVC.

4) An underlying communication technology, in which the TCP network and the ZigBee network are mainly adopted to realize a communication of the underlying equipment in the system.

5) A network surveillance camera, in which the webcam takes pictures of the robot and its environment, and sends the taken pictures to the host computer.

6) A transfer and debug module, in which the pictures taken by the network surveillance camera needs to be transcoded by the host computer to a format that the back end can recognize and the front end can display, and debugged to ensure that the camera playback screen is not delayed.

7) A camera code module, which adds the transferring and debugging code to the back end in the form of back-end code, and calls the camera code module to the back end through a front end control, thereby completing an entire monitoring system.

Different from the way that some similar monitoring systems are adopted as a part of the control system to affect the movement, the webcam in this embodiment is adopted to display the movement of the robot, and become a part of the decision-making system to enhance a connection between machines and human.

The working steps of the CPS-based remote control system for the robot of this embodiment are as follows.

1. The originals of different products are placed on a working position that the robot can clamp according to the production situation.

Since the CPS-based remote control system is applied to flexible production under intelligent manufacturing, operator-selectable workstations are set for handling work with different production materials and different weights, where these work cannot be handled manually. After the operator selects the product in the cloud manufacturing system, the raw materials or product components required for production can be intuitively selected according to their own preferences in the monitoring platform (i.e., the CPS-based monitoring system for the robot) of the cloud manufacturing system.

2. The robot in the information system is driven by using a touch device or a mouse.

Based on an existing environment of the information world of the robot, the robot model in the information system is driven through a touch device or a mouse, thereby realizing a movement or a rotation of the robot in the information system according to the movement of the terminal actuator. When materials or product components used for processing are decided, the operator can move the pneumatic finger model of the robot to the desired position.

3. The physical system of the robot moves according to the movement of the information system.

Aiming at the degree of movement of the robot in the information system, the Unity background converts information such as the amount of movement into a string that can be recognized by the control box, and transmits the string to the host computer through its server, so that the control box can obtain the corresponding string and control the robot to make a corresponding movement.

4. Decision feedback of the CPS-based monitoring system for the robot.

When the monitoring system finds that the production does not meet the needs of the operator, the operator can control the physical system to stop the production process through the information system, or replace the raw materials. The subsequent basic operation steps are the same as above.

What is claimed is:

1. A cyber-physical system (CPS)-based remote control system for a robot, comprising:
a modeling module for constructing a physical scene model of the robot according to a parameter of a real indoor environment where the robot is located, and constructing a 3D model of the robot according to a size parameter of the robot;
a render module for rendering the physical scene model and the 3D model of the robot;
a simulation module for constructing a rendered physical scene model and a rendered 3D model of the robot, thereby obtaining a simulation scene;
an instruction module for configuring a script of joints of the rendered 3D model of the robot in the simulation scene, collecting a model control signal to drive the rendered 3D model of the robot, and generating a string command according to a motion state of the rendered 3D model of the robot in the simulation scene; wherein the string command is provided for controlling movements of the robot in a real scene; and
a server module for sending the string command to a host computer of a controller of the robot.

2. The CPS-based remote control system of claim 1, wherein the physical scene model comprises an indoor space model and an indoor object model.

3. The CPS-based remote control system of claim 2, wherein the simulation module is provided for constructing a rendered indoor object model and the rendered 3D model of the robot in a rendered indoor space model according to the real scene, thereby obtaining the simulation scene consistent with the real scene.

4. The CPS-based remote control system of claim 1, wherein the simulation module constructs the simulation scene by using a Unity3D engine.

5. The CPS-based remote control system of claim 4, wherein the server module sends the string command of the robot to the controller of the robot via a communication module.

6. The CPS-based remote control system of claim 4, wherein the server module is constructed in the Unity3D engine.
